(19) United States
(12) Patent Application Publication
(10) Pub. No.: US 2003/0058258 A1
(43) Pub. Date: Mar. 27, 2003

(54) Digital image morphing and mapping process

(76) Inventors: Ted L. Simpson, Columbia, SC (US); Jeffrey Labuz, Malden, MA (US)

Correspondence Address: RALPHA BAILEY, P.A., ATTORNEYS AT LAW, 125 BROADUS AVENUE, GREENVILLE, SC, 29601, US

(21) Appl. No.: 09/960,965

(22) Filed: Sep. 24, 2001

(51) Int. Cl. G09G 5/00

(52) U.S. Cl. 345/646

(57) ABSTRACT

A method of digital image mapping includes utilizing a digitized image, morphing this image or tessellated regions of this image, and rearranging the resulting morphed image or image regions to produce a new image for printing on flexible media, such as paper, so that when a three-dimensional origami-like object is constructed from this media and it is viewed from a particular direction then the viewer observes the original image.

### BACKGROUND OF THE INVENTION

This invention relates to a method of applying images to construction surfaces utilizing pre-warped sections of digitized images. Image as used herein may signify a digital image, derived from any suitable source such as photographs, artwork or other two-dimensional material stored in computer memory.

The prior art is represented by any suitable multi-panel construction surface preferably a three-dimensional flexagonal construction as exemplified in U.S. Pat. No. 1,997,022. This patent includes an illustration of a hexaflexagon or kaleidocycle. Heretofore, images have been applied to the several facets of a hexaflexagon but there has been no effort to map pre-warped or morphed facets of digital images thereon.

Any desirable arrangement of the morphed facets may be utilized. Other three-dimensional configurations suitable for use with the invention include those exemplified in U.S. Pat. Nos. 3,611,617, 3,971,156, 4,240,858, and 4,735,418.

U.S. Pat. No. 5,995,110 discloses a method for transforming a flat image such as a photograph by morphing into a final deformed image which is then mapped onto a three-dimensional object.

### SUMMARY OF THE INVENTION

An important object of this invention is to provide a method of image morphing and mapping from a two-dimensional configuration to a three-dimensional configuration wherein, when viewed from a predetermined perspective, a morphed image will appear as in the original two-dimensional configuration.

Another important object of the invention is to segment and to morph a two-dimensional image into a configuration having adjacent segments disposed in predetermined angular relation such as flexagonal or polyhedral constructions to each other and to a viewer so as to appear as the original two-dimensional image.

The method, exemplified by use with a kaleidocycle or hexaflexagon, includes two steps: first, the image is segmented into twenty-four equilateral triangles; and second, these triangles are morphed, i.e., distorted intentionally, into triangles having dimensions suitable for constructing a three-dimensional device capable of flexing or rotating as exemplified in U.S. Pat. No. 1,997,022. Such morphing maps each image segment into a triangle which is not equilateral, but that has its height equal to its base. When the hexagonal-outlined image is rotated into view, each of its constituent facets projects to the viewer as if the image were in a plane. Or, to state it another way, from the perspective of someone looking at the image, the distortion in the real image is removed by the angular tilt of each facet from a flat plane.

Software useful herewith can employ any digital image in any suitable file format. Thus, text and hand-drawn images may be used as well as photographs or other material either directly made in digital form or scanned.

A preferred computer algorithm is provided for the decoration of a flat material such as paper to be used in the construction of origami models, objects assembled by a series of foldings of the material, and possibly, for the purposes of further exemplifying this invention, cuttings and/or gluings, tapings or other fastenings of the material with digitized images e.g., scanned photographs or artwork that have been sectioned or geometrically warped on geometric shapes so as to present the viewer of the assembled device with the original undistorted images when viewing from prescribed perspectives or when manipulating the device in a prescribed manner. Many other uses for the invention are expected to be developed and to appear as the method is utilized.

### BRIEF DESCRIPTION OF THE DRAWINGS

The construction designed to carry out the invention will be hereinafter described, together with other features thereof.

The invention will be more readily understood from a reading of the following specification and by reference to the accompanying drawings forming a part thereof, wherein an example of the invention is shown and wherein:

FIG. 1 illustrates a first step in the process according to the invention which includes image editing and shows a first image;

FIG. 2 is a top plan view illustrating the step of tessellating the first image to form the plate illustrated in FIG. 2;

FIG. 3 illustrates the step of installing a first image onto a suitable template having grid lines thereon;

FIG. 4 illustrates the step of editing and installing a second image onto the template as shown in FIG. 4-A;

FIG. 5 illustrates the third image and FIG. 5-A shows its installation onto the template;

FIG. 6 illustrates editing of a fourth and FIG. 6-A shows its installation onto the template to complete the composite image for storing and editing;

FIG. 7 is an enlarged view illustrating the ready image for assembly into a kaleidocycle or hexaflexagon;

FIG. 8 illustrates the use of isosceles triangles comprising each facet and showing a perspective of a viewer;

FIG. 9 is a top left perspective view illustrating a completed and assembled kaleidocycle or hexaflexagon omitting the image of FIG. 7;

FIG. 10 is a top plan view of the completed kaleidocycle or hexaflexagon rotated with sides abutting revealing the image of FIG. 1 without distortion when viewed from the perspective of a top plan view; and

FIG. 11 illustrates a method of constructing a kaleidocycle or hexaflexagon from the image of FIG. 7.

### DESCRIPTION OF A PREFERRED EMBODIMENT

The following description is illustrative of an exemplary application of the invention. The method may be utilized to create a variety of products to be assembled into various geometric configurations including polyhedra to be used for a variety of purposes, the pleasure of solving the puzzle posed by assembly, decorations as for Christmas trees, and as advertising devices. Therefore, the steps used in the creation of a kaleidocycle or hexaflexagon, shown below, are intended as typical of the whole family of objects or origami to be produced utilizing the program.

A suitable computer (not shown) may, for example, comprise a central processing unit with memory components such as a random access memory, a static memory and a storage means. These devices communicate with a keyboard, a cursor control device, a display device, and a printer.

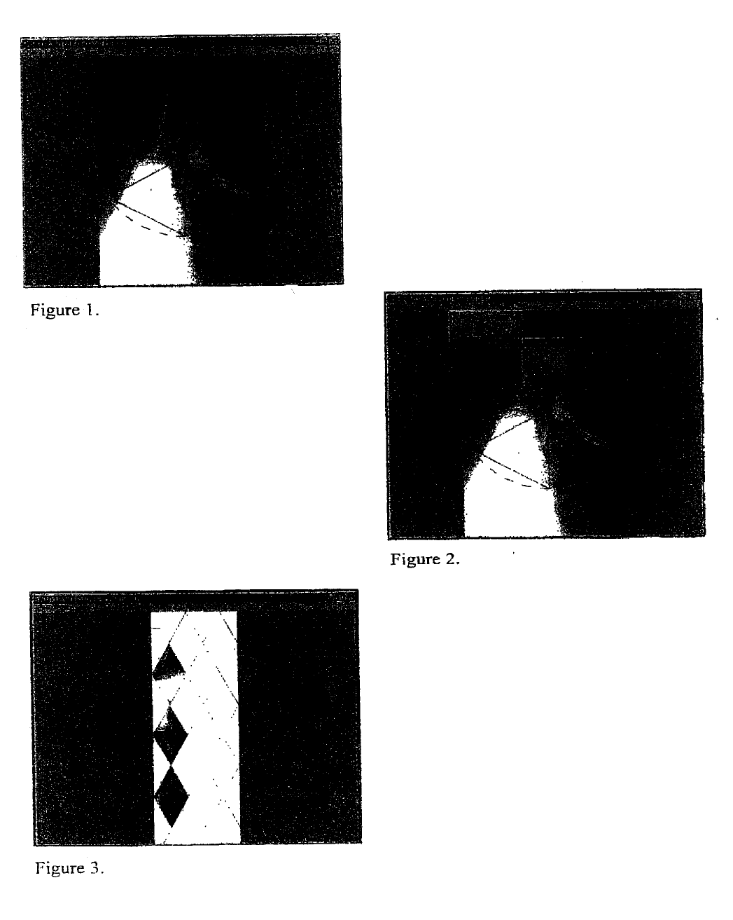

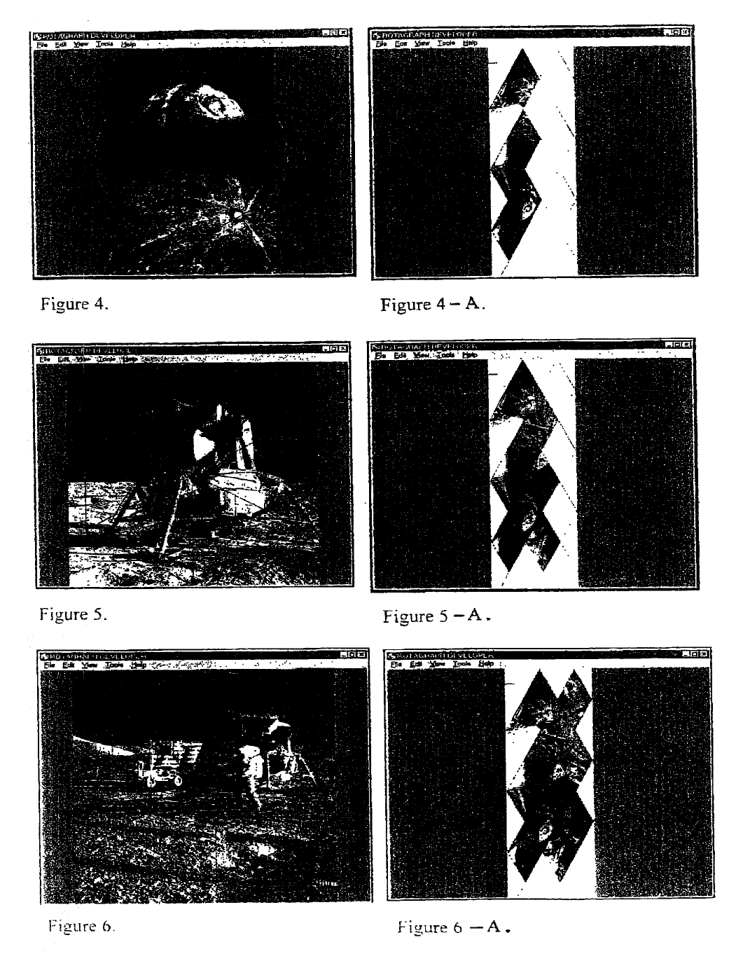

Four digital images are used in producing a kaleidocycle or hexaflexagon. The user of the computer is offered a menu of options as each image is opened for view. FIG. 1 shows the first image being edited just after the image file is opened. The image is placed upon a template such as the hexagonal template grid illustrated to guide the user in adjusting the size and orientation to fit the image to the template as illustrated in FIG. 2. When the user is satisfied with the image location and size, a suitable option is selected, which enables the user to place the image elements in position and orientation as the image shown in FIG. 3. Also shown in FIG. 3 is the grid outline, or template that is used as a guide for cutting and assembling. FIGS. 4, 5, and 6 show the second, third, and fourth images being edited and installed in proper orientation and position to complete the composite image for filing or printing.

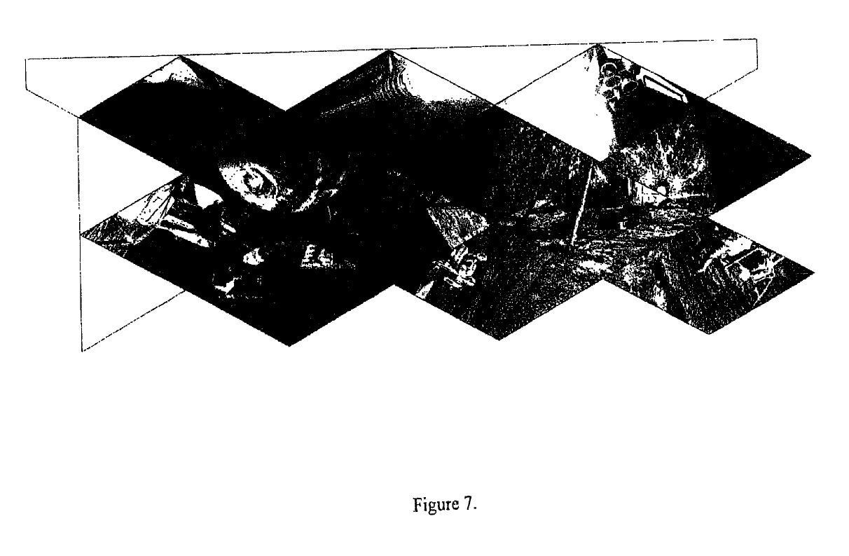

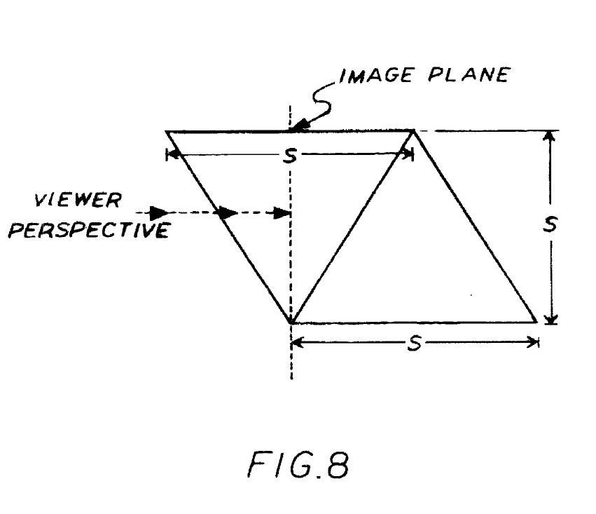

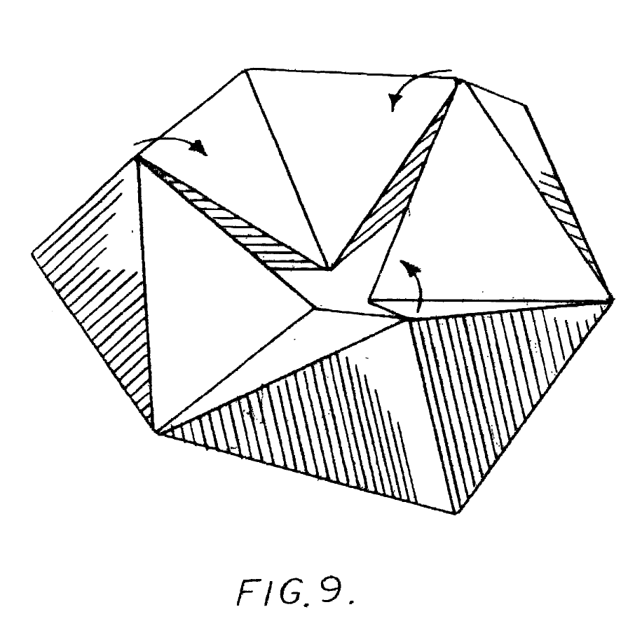

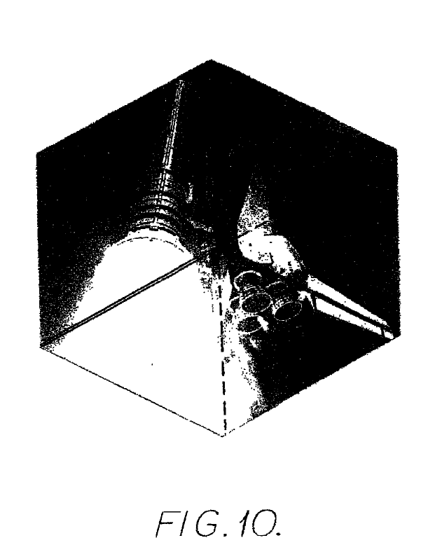

The twenty-four faces or facets of a hexaflexagon as illustrated in U.S. Pat. No. 1,997,022 consist of isosceles triangles with proportions as illustrated in FIG. 8. The dimensions are in the ratios shown in order that the image segments on each face will be perceived by the viewer in true form. The method by which each image segment is correctly placed on the final image, shown in FIG. 7, includes three steps.

First, each of the four images to be used are tessellated into equilateral triangles and stored in pairs and in proper sequence in computer memory.

Second, each triangular tessela, is transformed, morphed or pre-warped to the proportions shown in FIG. 8. This transformation increases the lengths of the two equal sides to (√5/2)s or 1.118s, an amount required for the projection shown.

Third, each transformed image segment is translated and rotated to the positions required for the original image to be constructed as a kaleidocycle or hexaflexagon as illustrated in FIG. 11 and described below. FIGS. 3, 4, 4-A, 5, 5-A, 6, and 6-A show the results after each of the four constituent images is placed onto the final composite image.

The following is a description of a preferred algorithm employed by the computer program to morph and map a kaleidocycle or hexaflexagon image onto the respective triangular faces.

The rotagraph mosaic image of FIG. 7 is created from the four digitized images, processed one at a time. The first step is to rotate the original image to the desired orientation, for example, (0, 90, 180, or 270 degrees, and then to position and size a hexagonal template over the portion of the image that is to be mapped into the respective mosaic image. Each of the six equilateral triangles that compose the hexagonal template on the original image are individually mapped to the corresponding six isosceles triangles, where their height equals their base, of the mosaic image as set forth below.

There is a single affine transformation that relates the coordinates of the vertices of any two triangles. Specifically, if (xij,yij) are the coordinates of the j-th vertex (j=1,2,3) of the i-th triangle (i=1,2), then there is a single set of affine parameters (a,b,c,d,e,f) for which x2j=a*x1j+b*y1j+c and y2j=d*x1j+e*y1j+f for all j. The calculation of the six affine parameters given the coordinates of the six vertices becomes the known problem of N linear equations in N unknowns, N being equal to 6 in this case.

The following procedure is repeated for each of the six side by side equilateral triangles of the hexagonal template. The affine parameters a,b,c,d,e,f that map the coordinates of the three vertices of the original image's equilateral triangle from the three vertices of the corresponding mosaic image's isosceles triangle are calculated. Then, starting with the coordinates of each picture element, or pixel, inside the rotagraf mosaic image's isosceles triangle, the coordinates of the corresponding pixel in the original image's equilateral triangle are calculated using the computed affine parameters. These coordinates are preferably rounded to the nearest integer, since pixel coordinates are integral, and the original image pixel i.e., the R, G, B color values are copied to the corresponding mosaic image pixel.

References on flexagons and kaleidocycles include website http://www.mathnstuff.com/papers/tetra/flex.htm. vides references and samples of several types of flexagons and kaleidocycles. A variety of these forms with digital images may be mapped to the various planes or faces of these objects which are called, generically, flexagons for flexible polygons. Although some are comprised of polyhedra, they present a more or less planar polygonal face, e.g., a hexagon, to the viewer.

The four-image kaleidocycle, one name for a four-image flexagon with hexagonal presentation, may be described with reference to a diagram with the Moon Landing, and assembly instructions as shown in the drawings. The actual flexagon is enlarged and printed on large enough paper to make it easy to cut out, fold, and assemble. For example, 17-in long copies using an HP 970se InkJet printer and MS Publisher's banner features may be utilized. However, 14-in legal paper will suffice for demonstrations.

For making a kaleidocycle, using a suitable knife all lines are scored, vertical and diagonal, for folding as illustrated in FIG. 11. Then fold and crease vertical broken lines with creases pointing toward the user, diagonal lines with creases pointing away from the user. Then, a suitable glue such as Elmer's is applied with folding and attachment as follows, letting the glue dry sufficiently between steps. Tab A is affixed to the back of B, C to back of D. Then F is covered with E, H with G, J with I, L with K, B with M, and E with N.

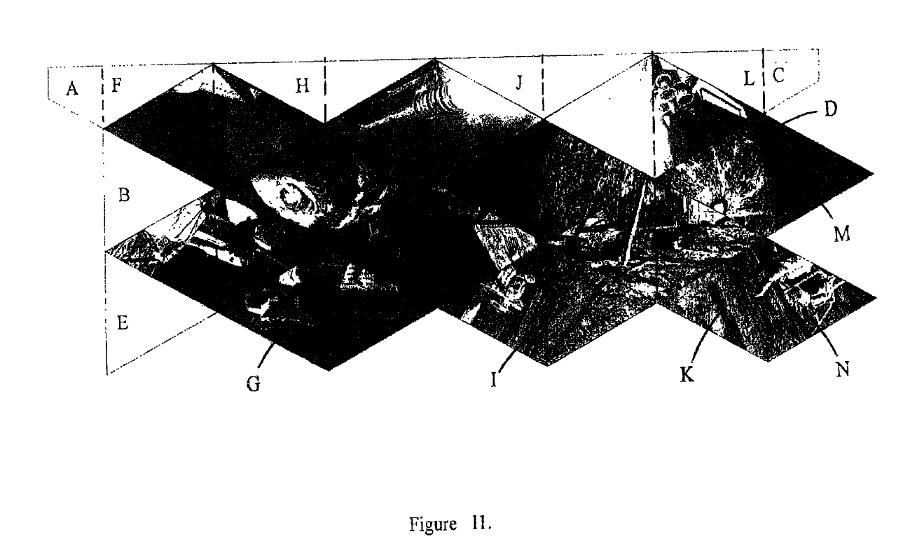

A completed kaleidocycle is illustrated, without images, in FIG. 9. By rotating the faces of the triangles as illustrated by the arrows each of the original four images may be viewed, appearing as undistorted when viewed from above with edges of the respective triangles abutting as in the top plan view of FIG. 10.

While a preferred embodiment of the invention has been described using specific terms, such description is for illustrative purposes only, and it is to be understood that changes and variations, including other morphing techniques and facet arrangements and configurations other than triangular, may be utilized without departing from the spirit or scope of the following claims.

What is claimed is:

1. A method of placing a digital two-dimensional image upon a three-dimensional shape including an origami construction comprising the steps of:
segmenting the image onto contiguous facets; and
morphing the segmented image on the contiguous facets to remove distortion as would otherwise appear to the viewer when viewing the three-dimensional image from a given perspective;
whereby the image when viewed from the given perspective appears to the viewer to be undistorted by the three-dimensional shape.

2. A method of digital image mapping comprising the steps of
tessellating a digital image on a planar surface;
segmenting the image into contiguous geometric shapes;
morphing the images on the shapes distorting the images; and
tilting the image into view wherein the shapes project the image as if in a plane thereby removing the distortion as viewed from a given perspective.

3. A method of digital image mapping for projection upon a three-dimensional configuration comprising the steps of:
providing a digitized image;
segmenting the image into a plurality of geometric shapes performing an affine transformation on the coordinates of each picture element, or pixel, within the shapes; and
tessellating each combination of shapes upon a surface forming a configuration for tilting into the three-dimensional configuration which when viewed from a certain perspective projects to the viewer the original digitized image.

4. The method of digital image mapping set forth in claim 3 wherein the shapes are isosceles triangles and the tilting is accomplished by rotating the surfaces.

5. The method of digital image mapping as set forth in claim 4 wherein the three-dimensional configuration is a flexagon.

6. The method of digital image mapping set forth in claim 5 wherein the three-dimensional configuration is a polyhedron.

7. The method of digital image mapping set forth in claim 6 wherein the three-dimensional configuration is a an origami construction.

8. A computer readable medium containing a computer program which executes the following steps:
segmenting a two-dimensional image into a plurality of facets which may be positioned in predetermined angular relation adjacent to each other;
warping the image segment appearing on respective facets so that when the facets are positioned in the predetermined angular relation and viewed from a predetermined perspective the facets appear to the viewer as the original two-dimensional image;
mapping the warped images on serveral facets on a flat surface; and
conforming the respective facets to the predetermined angular relation.

9. The computer readable medium of claim 8 wherein the respective facets on the flat surface when in the predetermined angular relation form a three-dimensional object.

10. The computer readable medium of claim 9 wherein the three-dimensional object is a polyhedron.

11. The computer readable medium of claim 10 wherein the three-dimensional object is a flexagon.

12. The computer readable medium of claim 11 wherein the three-dimensional object is a kaleidocycle or hexaflexagon.

13. The computer readable medium of claim 12 wherein the three-dimensional object is an origami construction.

14. The computer readable medium of claim 8 wherein the facets are triangular.

15. The computer readable medium of claim 8 wherein the warping step comprises the steps of performing an affine transformation.

16. The computer readable medium of claim 15 wherein each warped segment is translated and arranged to the positions required to view the original image from a predetermined perspective.

17. A method of constructing a three-dimensional object from a two-dimensional image comprising the steps of:
tessellating a two-dimensional image into polyhedra or curved shapes and storing them in proper sequence in computer memory;
morphing each polyhedron or curved shape to the proportions required to display the two-dimensional image;
translating and rotating each shape to the positions required for the polyhedron, flexagon, kaleidocycle, or other origami model to be constructed and viewed from a given perspective so that the original image is presented to the viewer.
